(19) United States
(12) Patent Application Publication
(10) Pub. No.: US 2023/0046585 A1
(43) Pub. Date: Feb. 16, 2023

(54) SYSTEMS AND METHODS FOR ANTICIPATORY LEASE MANAGEMENT WITH VEHICLE INTERACTION

(71) Applicant: Honda Motor Co., Ltd., Tokyo (JP)

(72) Inventors: Jennifer Wirth Symington, Los Angeles, CA (US); Christopher John Tarchala, Torrance, CA (US); Mark A. Blice, Huntington Beach, CA (US); Mohitash Brijwasi, La Palma, CA (US); Megan Ono, Gardena, CA (US); Tomoko Fukui, Torrance, CA (US)

(21) Appl. No.: 17/403,103

(22) Filed: Aug. 16, 2021

(51) Int. Cl. G06Q 30/02; G06Q 30/06

(52) U.S. Cl. CPC G06Q 30/0212; G06Q 30/0202; G06Q 30/0645

(57) ABSTRACT

A method for lease management includes receiving vehicle data, context data, and lease data related to a vehicle being leased by a vehicle occupant according to a set of leasing terms. At least the vehicle data is received from the vehicle. The method includes analyzing the vehicle data, the context data, and the lease data to predict a future event associated with the vehicle to offer a transaction offer. Further the method includes, selecting a bundle product for the transaction offer from a plurality of products based on the vehicle data, the context data, and the lease data. Upon detecting a start of the future event, the method includes transmitting the transaction offer including the bundle product.

### BACKGROUND

Purchasing a vehicle is often a challenging process due to the numerous vehicles available, all having different options and slight nuances. Customers often go through a pain staking process of researching many vehicles and different technologies, while also having to consider personal buying factors. For manufacturers and/or dealerships, it is difficult and expensive to understand customer needs and buying behaviors in order to capture new customers and build or maintain brand loyalty.

In the realm of leasing, where one car is leased to one person at a time for a predetermined period of time, guaranteeing repeat purchasing behavior and/or building brand loyalty can be even more difficult. Increasing customer demand for flexibility, conveniences, and new features make it challenging to determine and/or predict customer needs for their next vehicle. Incentives can be provided to encourage customers to enter a new lease, however, with rising competition and thinner margins, incentives alone do not guarantee repeat purchasing behavior. Additionally, because of the isolated one-and-done lease transaction, customers are not fully exposed to all offerings from a multifaceted brand, which could provide opportunities for brand loyalty and vehicle deliveries throughout the life of the lease. Leasing management systems have not evolved to the dynamic nature of vehicle leasing and do not provide technological solutions to address these challenges.

### BRIEF DESCRIPTION

According to one aspect, a computer-implemented method for lease management includes receiving vehicle data, context data, and lease data related to a vehicle being leased by a vehicle occupant according to a set of leasing terms. At least the vehicle data is received from the vehicle. The method includes analyzing the vehicle data, the context data, and the lease data to predict a future event associated with the vehicle to offer a transaction offer. Further the method includes, selecting a bundle product for the transaction offer from a plurality of products based on the vehicle data, the context data, and the lease data. Upon detecting a start of the future event, the method includes transmitting the transaction offer including the bundle product. Other embodiments of this aspect include corresponding computer systems, apparatus, and computer programs recorded on one or more computer storage devices, each configured to perform the actions of the methods.

According to another aspect, a lease management system includes a vehicle, being leased by a vehicle occupant according to a set of leasing terms, and a processor. The processor is operatively connected for computer communication to the vehicle. The processor receives vehicle data, context data, and lease data related to the vehicle. At least the vehicle data is received from the vehicle and is captured by vehicle sensors of the vehicle. The processor predicts a future transaction-based event associated with the vehicle. The processor also selects a bundle product from a plurality of products based on the vehicle data, the context data, and the lease data. Upon the processor detecting initiation of the future event, the processor transmits a transaction offer including the bundle product. Other embodiments of this aspect include corresponding computer systems, apparatus, and computer programs recorded on one or more computer storage devices, each configured to perform the actions of the methods.

According to a further aspect, a non-transitory computer-readable storage medium includes instructions for a lease management system. The instructions cause a processor to receive vehicle data, context data, and lease data related to a vehicle being leased by a vehicle occupant according to a set of leasing terms. At least the vehicle data is received from the vehicle. The instructions cause the processor to analyze the vehicle data, the context data, and the lease data to predict a future event associated with the vehicle to offer a transaction offer. Further, the instructions cause the processor to select a bundle product for the transaction offer from a plurality of products based on the vehicle data, the context data, and the lease data. Upon the instructions causing the processor to detect a start of the future event, the instructions cause the processor to transmit the transaction offer including the bundle product. Other embodiments of this aspect include corresponding computer systems, apparatus, and computer programs recorded on one or more computer storage devices, each configured to perform the actions of the methods.

### BRIEF DESCRIPTION OF THE DRAWINGS

The accompanying drawings, which are incorporated in and constitute a part of the specification, illustrate various systems, methods, devices, and other embodiments of the disclosure. It will be appreciated that the illustrated element boundaries (e.g., boxes, groups of boxes, directional lines, or other shapes) in the figures represent one embodiment of the boundaries. In some embodiments one element may be designed as multiple elements or that multiple elements may be designed as one element. In some embodiments, an element shown as an internal component of another element may be implemented as an external component and vice versa. Furthermore, elements may not be drawn to scale.

FIG. 1 is a block diagram of a lease management system according to an exemplary embodiment;

FIG. 2 is a process flow diagram of a method for lease management according to an exemplary embodiment; and

FIG. 3 is a process flow diagram of a method for lease management according to another exemplary embodiment.

### DETAILED DESCRIPTION

### I. Definitions

The following includes definitions of selected terms employed herein. The definitions include various examples and/or forms of components that fall within the scope of a term and that may be used for implementation. The examples are not intended to be limiting. Further, the components discussed herein, may be combined, omitted or organized with other components or into different architectures.

“Bus,” as used herein, refers to an interconnected architecture that is operably connected to other computer components inside a computer or between computers. The bus may transfer data between the computer components. The bus may be a memory bus, a memory processor, a peripheral bus, an external bus, a crossbar switch, and/or a local bus, among others. The bus may also be a vehicle bus that interconnects components inside a vehicle using protocols such as Media Oriented Systems Transport (MOST), Controller Area network (CAN), Local Interconnect network (LIN), among others.

“Component,” as used herein, refers to a computer-related entity (e.g., hardware, firmware, instructions in execution, combinations thereof). Computer components may include, for example, a process running on a processor, a processor, an object, an executable, a thread of execution, and a computer. A computer component(s) may reside within a process and/or thread. A computer component may be localized on one computer and/or may be distributed between multiple computers.

“Computer communication,” as used herein, refers to a communication between two or more computing devices (e.g., computer, personal digital assistant, cellular telephone, network device, vehicle, vehicle computing device, infrastructure device, roadside device) and may be, for example, a network transfer, a data transfer, a file transfer, an applet transfer, an email, a hypertext transfer protocol (HTTP) transfer, and so on. A computer communication may occur across any type of wired or wireless system and/or network having any type of configuration, for example, a local area network (LAN), a personal area network (PAN), a wireless personal area network (WPAN), a wireless area network (WAN), a wide area network (WAN), a metropolitan area network (MAN), a virtual private network (VPN), a cellular network, a token ring network, a point-to-point network, an ad hoc network, a mobile ad hoc network, a vehicular ad hoc network (VANET), a vehicle-to-vehicle (V2V) network, a vehicle-to-everything (V2X) network, a vehicle-to-infrastructure (V2I) network, among others. Computer communication may utilize any type of wired, wireless, or network communication protocol including, but not limited to, Ethernet (e.g., IEEE 802.3), WiFi (e.g., IEEE 802.11), communications access for land mobiles (CALM), WiMax, Bluetooth, Zigbee, ultra-wideband (UWAB), multiple-input and multiple-output (MIMO), telecommunications and/or cellular network communication (e.g., SMS, MMS, 3G, 4G, LTE, 5G, GSM, CDMA, WAVE), satellite, dedicated short range communication (DSRC), among others.

“Computer-readable medium,” as used herein, refers to a non-transitory medium that stores instructions and/or data. A computer-readable medium may take forms, including, but not limited to, non-volatile media, and volatile media. Non-volatile media may include, for example, optical disks, magnetic disks, and so on. Volatile media may include, for example, semiconductor memories, dynamic memory, and so on. Common forms of a computer-readable medium may include, but are not limited to, a floppy disk, a flexible disk, a hard disk, a magnetic tape, other magnetic medium, an ASIC, a CD, other optical medium, a RAM, a ROM, a memory chip or card, a memory stick, and other media from which a computer, a processor or other electronic device may read.

“Database,” as used herein, is used to refer to a table. In other examples, “database” may be used to refer to a set of tables. In still other examples, “database” may refer to a set of data stores and methods for accessing and/or manipulating those data stores. A database may be stored, for example, at a disk and/or a memory.

“Memory,” as used herein may include volatile memory and/or nonvolatile memory. Non-volatile memory may include, for example, ROM (read only memory), PROM (programmable read only memory), EPROM (erasable PROM), and EEPROM (electrically erasable PROM). Volatile memory may include, for example, RAM (random access memory), synchronous RAM (SRAM), dynamic RAM (DRAM), synchronous DRAM (SDRAM), double data rate SDRAM (DDRSDRAM), and direct RAM bus RAM (DRRAM). The memory may store an operating system that controls or allocates resources of a computing device.

“Operable connection,” or a connection by which entities are “operably connected,” is one in which signals, physical communications, and/or logical communications may be sent and/or received. An operable connection may include a wireless interface, a physical interface, a data interface, and/or an electrical interface.

“Processor,” as used herein, processes signals and performs general computing and arithmetic functions. Signals processed by the processor may include digital signals, data signals, computer instructions, processor instructions, messages, a bit, a bit stream, that may be received, transmitted and/or detected. Generally, the processor may be a variety of various processors including multiple single and multicore processors and co-processors and other multiple single and multicore processor and co-processor architectures. The processor may include logic circuitry to execute actions and/or algorithms.

“Vehicle,” as used herein, refers to any moving vehicle capable of carrying one or more human occupants and is powered by any form of energy. The term “vehicle” includes, but is not limited to cars, trucks, vans, minivans, SUVs, motorcycles, scooters, boats, go-karts, amusement ride cars, rail transport, personal watercraft, and aircraft. In some cases, a motor vehicle includes one or more engines or can be powered entirely or partially by an electric battery. The term “vehicle” may also refer to an autonomous vehicle and/or self-driving vehicle powered by any form of energy. The autonomous vehicle may carry one or more human occupants. The autonomous vehicle may have any level or mode of driving automation ranging from, for example, fully manual to fully autonomous. Further, the term “vehicle” may include vehicles that are automated or non-automated with pre-determined paths or free-moving vehicles.

### II. System Overview

As mentioned briefly above in the Summary, typical lease management systems and architectures are static and disparate and therefore fail to dynamically integrate systems and information across different functional systems during the leasing process. For example, lease management systems may provide typical processing at the beginning of a lease and at the end of the lease, however, there is no integration during the life of the lease and after the lease ends. Once the lease ends, the vehicle is turned in, and the customer either signs a new lease or walks away. There are no technical systems or mechanisms in place to provide dynamic and interactive lease management with the vehicle and the customer. Furthermore, these lease management systems are unable to obtain real time information to curate transactions during the life of the lease and/or at the end of the lease.

Accordingly, the methods and systems described herein provide the technical solution of a system architecture for lease management having distributed data gathering and processing, using data from the vehicle to predict an upcoming transaction associated with the vehicle and anticipate customer needs in light of a brand's product offerings. This technical solution may contribute to the technical problem by ensuring the lease termination experience is maximized, not only for the brand, but also for the customer.

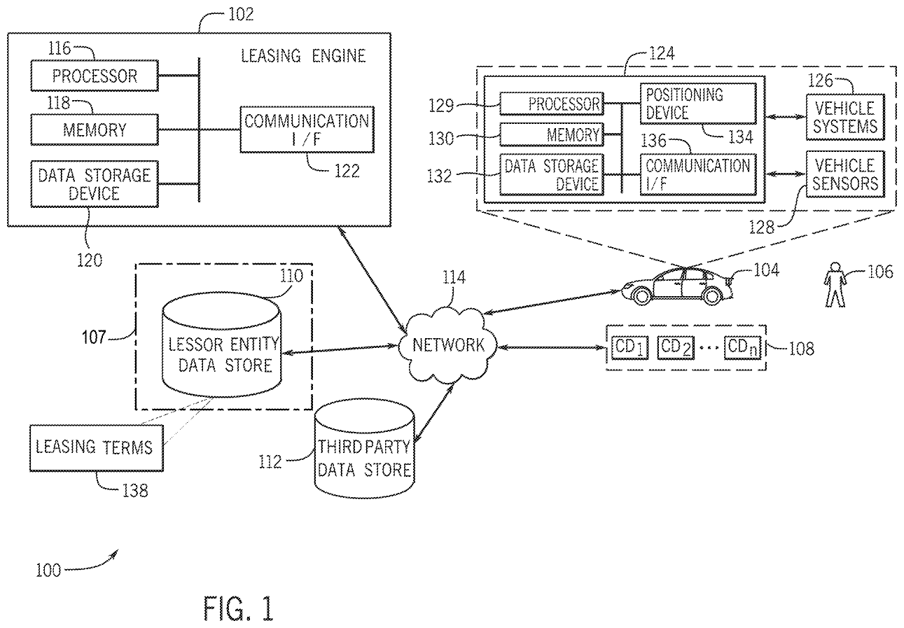

Referring now to the drawings, wherein the showings are for purposes of illustrating one or more exemplary embodiments and not for purposes of limiting same, FIG. 1 is a block diagram of a lease management system 100 according to an exemplary embodiment. Generally, the lease management system 100 includes a computing device 102 (i.e., a leasing engine), a vehicle 104 associated with a vehicle occupant 106 (e.g., a lessee, a lessee entity, a driver), one or more connected devices 108, a lessor entity data store 110, and a third-party data store 112, each operably connected for communication via a network 114. It is understood that the components of the lease management system 100, as well as the components of other systems, hardware architectures, and software architectures discussed herein, may be combined, omitted, or organized into different architectures for various embodiments.

The computing device 102 includes a processor 116, a memory 118, a data storage device 120, and a communication interface (I/F) 122. As shown in FIG. 1, each component of the computing device 102 are operably connected for computer communication via a bus, however, other wired and wireless technologies defined herein can be implemented. The computing device 102 can include provisions for processing, communicating and interacting with various components of the computing device 102 and other components of the lease management system 100.

The processor 116 may include logic circuitry with hardware, firmware, and software architecture frameworks for facilitating lease management as described herein. Thus, in some embodiments, the processor 116 may store application frameworks, kernels, libraries, drivers, application program interfaces, among others, to execute and control hardware and functions discussed herein. In some embodiments, the memory 118 and/or the data storage device 120 may store similar components as the processor 116 for execution by the processor 116.

Referring again to the computing device 102, the communication I/F 122 may include software and hardware to facilitate data input and output between the components of the computing device 102 and other components of the lease management system 100. Specifically, the communication I/F 122 may include input/output devices, network interface controllers, and other hardware and software that manages and/or monitors connections, controls bi-directional data transfer between the communication I/F 122 and other components of the lease management system 100 using, for example, the network 114. According to one embodiment, the computing device 102, using the communication I/F 122, can receive and/or access data from the vehicle 104, one or more of the connected devices 108, the lessor entity store 110, and/or the third-party data store 112. This data, which will be discussed in further detail herein, facilitates prediction of an upcoming transaction and bundle product offering.

The vehicle 104 is a vehicle leased by the vehicle occupant 106 from an owner. The owner can be, for example, a lessor, a lessor entity, and/or an Original Equipment Manufacturer (OEM). In the embodiments discussed herein and in FIG. 1, the owner is referred to as a lessor entity 107. Accordingly, the vehicle 104 is leased by the vehicle occupant 106 from the lessor entity 107 according to a set of leasing terms 138. Thus, the vehicle occupant 106 is using the vehicle 104 for a fixed period of time and at an agreed amount of money while the lessor entity 107 remains the legal owner of the vehicle 104. The set of leasing terms 138 define the meets and boundaries of the lease relationship with the lessor entity 107. For example, the set of leasing terms 138 can include, but is not limited to, vehicle identification (e.g., make, model, VIN), a length of the lease, a lease start date, a lease end date, a monthly lease cost, a lease interest rate, a lease mileage limitation, insurance obligations, among others. As shown in FIG. 1, in some embodiments, the set of leasing terms 138 for the vehicle 104 is stored at the lessor entity data store 110. The lessor entity data store 110 can be owned and/or managed by the lessor entity 107.

Referring again to the vehicle 104, the vehicle 104 includes a vehicle computing device 124, vehicle systems 126, and vehicle sensors 128. The vehicle computing device 124 include provisions for processing, communicating and interacting with various components of the vehicle 104 and other components of the lease management system 100, including the computing device 102 (i.e., the leasing engine). In one embodiment, the vehicle computing device 124 can be implemented with the vehicle 104, for example, as part of a telematics unit, a head unit, an infotainment unit, an electronic control unit, an on-board unit, or as part of a specific vehicle control system, among others.

Generally, the vehicle computing device 124 includes a processor 129, a memory 130, a data storage device 132, a positioning device 134, and a communication interface (I/F) 136. For brevity, it is understood that similar named components of the vehicle computing device 124 can perform similar functions described herein with respect to the computing device 102. Therefore, these components (i.e., the processor 129, the memory 130, the data storage device 132, and the communication I/F 136) will not be discussed in detail. With respect to the positioning device 134, it can include hardware (e.g., sensors) and software to determine and/or acquire position data about the vehicle 104. For example, the positioning device 134 can include a global positioning system (GPS) unit (not shown) and/or an inertial measurement unit (IMU) (not shown).

The vehicle systems 126 can include any type of vehicle control system and/or vehicle system described herein to enhance the vehicle 104 and/or driving of the vehicle 104. Furthermore, the vehicle sensors 128, which can be implemented alone and/or with the vehicle systems 126, can include various types of sensors for use with the vehicle 104 and/or the vehicle systems 126 for detecting and/or sensing a parameter of the vehicle 104, the vehicle systems 126, the environment surrounding the vehicle 104, and/or the vehicle occupant 106. As will be discussed in further detail herein, data captured by the vehicle sensors 128 can be communicated to the computing device 102 and used for predicating an upcoming transaction and selecting a bundle product. Although not shown in FIG. 1, it will be understood that one or more of the vehicle sensors 128 could be disposed in one or more portions of the vehicle 104. For example, the sensors could be integrated into a dashboard, seat, seat belt, door, dashboard, steering wheel, center console, roof or any other portion of the vehicle 104. In other cases, however, the sensors could be portable sensors worn by the vehicle occupant 106 and/or integrated with a portable device (e.g., the one or more of the connected devices 108) carried by the vehicle occupant 106, integrated into an article of clothing worn by the vehicle occupant 106 or integrated into the body of the vehicle occupant 106 (e.g. an implant).

Referring again to FIG. 1, the one or more connected devices 108 can be any type of computing device associated with the vehicle 104 and/or the vehicle occupant 106. For example, the one or more connected devices 108 can include, but are not limited to, handheld devices, wearable devices, mobile devices, smart phones, laptops, tablets and e-readers. It is appreciated that although not shown in FIG. 1, the one or more connected devices 108 may include one or more components similar to the components of the computing device 102, the vehicle computing device 124 and/or perform similar functions described herein with respect to the computing device 102 and/or the vehicle computing device 124. For example, the one or more connected devices may include processor(s), sensors, and other components implementing the systems and methods discussed herein. Using the system and network configuration discussed above, anticipatory and personalized lease management is implemented as discussed in further detail herein.

### III. Vehicle Interaction for Anticipatory Lease Management

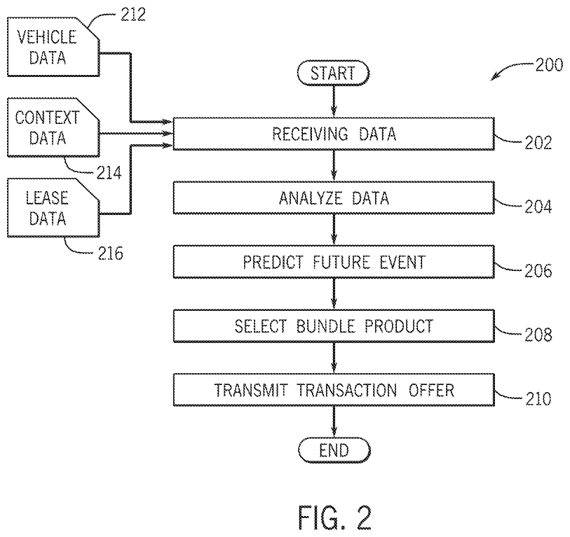

Before describing exemplary methods for anticipatory lease management, the data utilized will be described in more detail. As mentioned above, real-time data from the vehicle 104 and/or the vehicle occupant 106 is captured and communicated for analysis to predict an upcoming transaction and/or select a bundle product to be transmitted with the transaction. Additionally, other data about the lease and context data about the vehicle 104 and/or the vehicle occupant 106 can be utilized. Accordingly, as used herein and with reference to FIGS. 1 and 2, the system 100 can utilize vehicle data 212, context data 214, and lease data 216.

The vehicle data 212 is data that is captured by the vehicle 104, for example, by the vehicle systems 126 and/or the vehicle sensors 128, and can include vehicle system conditions, states, statuses, behaviors, and information about the external environment of the vehicle (e.g., other vehicles, pedestrians, objects, road conditions, weather conditions). In particular, the vehicle data 212 can include vehicle dynamics data about the operation of the vehicle 104 and/or vehicle occupant data about the vehicle occupant 106. The vehicle dynamics data can include, but is not limited to, engine info (e.g., velocity or acceleration), steering information, lane information, lane departure information, blind spot monitoring information, braking information, collision warning information, navigation/position information (e.g., from the positioning device 134), HVAC information, collision mitigation information and automatic cruise control information. In some cases, the vehicle dynamics data can also be related to the vehicle occupant of the vehicle 104 (e.g., steering information may be related to a state of a driver, navigation/position information may be related to a residence and/or work place of the vehicle occupant 106).

As mentioned above, the vehicle sensors 128 can include image sensors and/or biometric sensors. Accordingly, the vehicle occupant data can include physiological data about the human body (e.g., the vehicle occupant 106). For example, heart rate, pulse, pupil dilation, gaze, respiratory rate, among others. It is understood that the vehicle data 212 can include historical vehicle data and baseline vehicle data that is stored and/or retrieved at the vehicle 104 (e.g., at the data storage device 132).

The context data 214 can include contextual information about the vehicle 104 and/or the vehicle occupant 106 that can be mined from, for example, the one or more connected devices 108, the lessor entity data store 110, and the third-party data store 112. For example, context data 214 can include vehicle occupant profile information, for example, demographics, occupation, hobbies, family members living in the same household, pets, residential address, work address, assets, income, purchase history, social media interests, internet browsing data, geopositioned data movements, travel history, memberships among others. The context data 214 can also include other types of lifestyle information that can be mined from the vehicle 104, for example, from an infotainment system, or other types of lifestyle information from the one or more connected devices, the lessor entity data store 110, the and/or third-party data store 112.

The lease data 216 can include information about the lease relationship involving the vehicle 104, the vehicle occupant 106, and the lessor entity 107. For example, as described above, the lease data 216 can include the leasing terms 138 stored at the lessor entity data store 110. In some embodiments, the lease data 216 can include financial information involved with the lease. In this case, the third-party data store 112 can be a financial institution data store where the financial information can be retrieved.

It is understood that the vehicle data 212, the context data 214, and the lease data 216 can be retrieved and/or accessed (e.g., by the computing device 102) upon determination of a trigger and/or event or on a predetermined interval basis. It is further understood that the vehicle data 212, the context data 214, and the lease data 216 can include historical data and/or baseline data that is stored and/or retrieved. Access to these types of information allows for an accurate and customized lease management, methods of which will now be described in more detail.

### IV. Methods for Anticipatory Lease Management

Referring now to FIG. 2, a method 200 for lease management according to an exemplary embodiment is shown. FIG. 2 will be discussed with reference to the components of FIG. 1. As shown in FIG. 2, at block 202, the method 200 includes receiving data. The data can include vehicle data 212, context data 214, and lease data 216. The vehicle data 212, the context data 214, and the lease data 216 are related to the vehicle 104 and/or the vehicle occupant 106, where the vehicle 104 is being leased by the vehicle occupant 106 from an owner and/or the lessor entity 107 according to the set of leasing terms 138. As discussed above in detail, the vehicle data 212 is received from the vehicle 104 and can include any data captured and/or measured by the vehicle systems 126 and/or the vehicle sensors 128. The computing device 102 via the processor 116 can receive and/or access the vehicle data 212 from the vehicle 104.

As discussed above in detail, in one embodiment, the vehicle data 212 includes data about the vehicle occupant 106 captured by the vehicle sensors 128 of the vehicle 104. The data about the vehicle occupant 106 includes biometric data captured by the vehicle sensors 128. As will be discussed herein, a future transaction event is determined and/or a bundle product is selected based on the biometric data.

Referring again to the method 200, block 204 analyzing data to determine a set of criteria for selecting the bundle product and/or for predicting the future event (e.g., at block 206). In some embodiments, the set of criteria includes characteristics about the vehicle 104, the vehicle occupant 106, and/or the set of leasing terms 138. As one example, income of the vehicle occupant 106 can be a type of criteria used to select the bundle product. As another example, the type (e.g., sedan, SUV, truck) of the vehicle 104 can be a type of criteria used to select the bundle product. At block 206, the method 200 includes predicting a future event. The future event is a transaction-based event associated with the vehicle 104. As an illustrative example, a transaction-based event can be a service appointment and/or a vehicle maintenance milestone associated with the vehicle 104. In this example, a date of the transaction-based event can be determined from the context data 214 (e.g., an appointment scheduled in a digital calendar associated with the vehicle occupant 106). As another example, the transaction-based event is an event that is set to occur within a predetermined time period of the termination of the lease associated with the vehicle 104. In some embodiments, the transaction-based event can be identified as the lease termination and/or a time span where the vehicle 104 can be turned back into the lessor entity 107 and the lessor entity 107 can offer a new lease.

At block 208, the method 200 includes selecting a bundle product. The bundle product is selected from a plurality of products offered by the lessor entity 107. Specifications about the plurality of products can be stored, for example, at the lessor entity data store 110. The selection is based on the vehicle data 212, the context data 214, and the lease data 216. In some embodiments, the selection is also based on the specifications of the plurality of products. The bundle product is not associated with the vehicle and/or the lease of the vehicle. Said differently, the plurality of products can be a line of products offered by the lessor entity 107 (e.g., an OEM) where the line of products is different from a line of vehicles offered for leasing. As an illustrative example, the lessor entity 107 may offer a line of vehicles and a line of power products (e.g., lawn mowers, power sources, generators, tillers, assistance devices, scooters, water pumps, snow blowers, leaf blowers). In this example, the bundle product is selected from the line of power products. In some embodiments, the lessor entity 107 may offer a line of services (e.g., maintenance plans, customer service plans). The line of services may be associated with another product offered by the lessor entity 107.

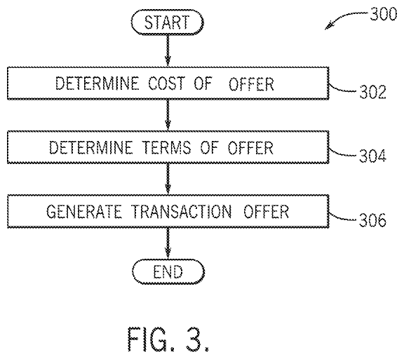

Referring again to the method 200, block 210 includes transmitting a transaction offer. In some embodiments, transmission of the transaction offer is initiated upon detection of a start of the transaction-based event predicted at block 206. For example, upon determining initiation of a transaction associated with a repair of the vehicle 104, the processor 116 can transmit the transaction offer, to for example, one or more of the connected devices 108. The transaction offer includes the selected bundle product. In some embodiments, the transaction offer includes the selected bundle product and a new lease for another vehicle. Determination and transmission of the transaction offer will also be described in more detail with FIG. 3.

Referring now to FIG. 3, a method 300 for lease management according to an exemplary embodiment is shown. FIG. 3 will be described with reference to FIGS. 1 and 2. At block 302, the method 300 includes determining a cost of the transaction offer. In one embodiment, the cost of the transaction offer is based on the lease data 216 (e.g., the set of leasing terms 138) and a cost of the bundle product. In some embodiments, the cost of the transaction offer can be based on the mileage and/or condition of the vehicle 104 determined in part on the vehicle data 212. In some embodiments, the cost of the transaction offer is discounted based on the bundle product and/or a new vehicle lease.

At block 304, the method 300 includes determining terms of the transaction offer. For example, in addition to the cost of the bundle, a new set of leasing terms can be determined based on the vehicle data 212, the context data 214, and the lease data 216.

Furthermore, at block 306, the method 300 includes generating the transaction offer including the selected bundle product, the cost of the transaction offer, and the terms of the transaction offer. The transaction offer can then be transmitted as described at block 210 of the method 200. In one embodiment, the transaction offer is transmitted to a point-of-sale computing device (e.g., a computing device at a vehicle repair station and/or the dealership). Accordingly, the systems and methods described herein provide technical mechanisms to assist customers with lease termination and lease renewal, as well as, improved dynamic and streamlined lease management.

It will be appreciated that various embodiments of the above-disclosed and other features and functions, or alternatives or varieties thereof, may be desirably combined into many other different systems or applications. Also, that various presently unforeseen or unanticipated alternatives, modifications, variations or improvements therein may be subsequently made by those skilled in the art which are also intended to be encompassed by the following claims.

1. A computer-implemented method for lease management, comprising:
receiving vehicle data, context data, and lease data related to a vehicle being leased by a vehicle occupant according to a set of leasing terms, wherein at least the vehicle data is received from the vehicle;
analyzing the vehicle data, the context data, and the lease data to predict a future event associated with the vehicle to offer a transaction offer;
selecting a bundle product for the transaction offer from a plurality of products based on the vehicle data, the context data, and the lease data; and
upon detecting a start of the future event, transmitting the transaction offer including the bundle product.

2. The computer-implemented method of claim 1, wherein the vehicle data includes data about the vehicle occupant captured by vehicle sensors of the vehicle.

3. The computer-implemented method of claim 2, wherein the data about the vehicle occupant includes biometric data captured by the vehicle sensors and selecting the bundle product is based on the biometric data and a set of specifications for the bundle product.

4. The computer-implemented method of claim 1, wherein analyzing the vehicle data, the context data, and the lease data includes determining a set of criteria for selecting the bundle product.

5. The computer-implemented method of claim 1, wherein the bundle product is not associated with the vehicle.

6. The computer-implemented method of claim 1, wherein the vehicle is leased by the vehicle occupant from a lessor entity and the plurality of products are from a line of products offered by the lessor entity and are not related to the vehicle, and the bundle product is selected from the line of products.

7. The computer-implemented method of claim 1, wherein the transaction offer includes renewal of the set of leasing terms and the bundle product.

8. The computer-implemented method of claim 1, further including determining a cost of the transaction offer based on the lease data and the bundle product, wherein the transaction offer includes renewal of the set of leasing terms and the bundle product.

9. A lease management system, comprising:
a vehicle being leased by a vehicle occupant according to a set of leasing terms; and
a processor operatively connected for computer communication to the vehicle, wherein the processor:
receives vehicle data, context data, and lease data related to the vehicle, wherein at least the vehicle data is received from the vehicle and is captured by vehicle sensors of the vehicle;
predicts a future transaction-based event associated with the vehicle;
selects a bundle product from a plurality of products based on the vehicle data, the context data, and the lease data; and
upon detecting initiation of the future event, transmits a transaction offer including the bundle product.

10. The lease management system of claim 9, wherein the vehicle data includes data about the vehicle occupant captured by the vehicle sensors of the vehicle.

11. The lease management system of claim 10, wherein the data about the vehicle occupant includes biometric data captured by the vehicle sensors, and the processor selects the bundle product is based on the biometric data and a set of specifications for the bundle product.

12. The lease management system of claim 9, wherein the vehicle is leased by the vehicle occupant from a lessor entity and the plurality of products are from a line of products offered by the lessor entity and not related to the vehicle, and the bundle product is selected from the line of products.

13. The lease management system of claim 9, wherein the transaction offer includes renewal of the set of leasing terms and the bundle product.

14. The lease management system of claim 9, wherein the processor determines a cost of the transaction offer based on the lease data and the bundle product, wherein the transaction offer includes renewal of the set of leasing terms and the bundle product.

15. A non-transitory computer-readable storage medium including instructions for a lease management system, that when executed by a processor cause the processor to:
receive vehicle data, context data, and lease data related to a vehicle being leased by a vehicle occupant according to a set of leasing terms, wherein at least the vehicle data is received from the vehicle;
analyze the vehicle data, the context data, and the lease data to predict a future event associated with the vehicle to offer a transaction offer;
select a bundle product for the transaction offer from a plurality of products based on the vehicle data, the context data, and the lease data; and
upon detecting a start of the future event, transmit the transaction offer including the bundle product.

16. The non-transitory computer-readable storage medium of claim 15, wherein the vehicle data includes data about the vehicle occupant captured by vehicle sensors of the vehicle.

17. The non-transitory computer-readable storage medium of claim 16, wherein the data about the vehicle occupant includes biometric data captured by vehicle sensors, and the instructions for the lease management system cause the processor to select the bundle product based on the biometric data and a set of specifications for the bundle product.

18. The non-transitory computer-readable storage medium of claim 15, wherein the vehicle is leased by the vehicle occupant from a lessor entity and the plurality of products are a line of products offered by the lessor entity and are not related to the vehicle, and the bundle product is selected from the line of products.

19. The non-transitory computer-readable storage medium of claim 15, wherein the transaction offer includes renewal of the set of leasing terms and the bundle product.

20. The non-transitory computer-readable storage medium of claim 15, wherein the instructions for the lease management system cause the processor to determine a cost of the transaction offer based on the lease data and the bundle product, wherein the transaction offer includes renewal of the set of leasing terms and the bundle product.
